(19) United States
(12) Patent Application Publication
(10) Pub. No.: US 2023/0290983 A1
(43) Pub. Date: Sep. 14, 2023

(54) ENERGY STORAGE DEVICE, IN PARTICULAR A REDOX FLOW BATTERY

(71) Applicant: VANEVO GMBH, Oldenburg (DE)

(72) Inventors: Jan GROSSE AUSTING, Oldenburg (DE); Arne GROSSE AUSTING, Bochum (DE)

(21) Appl. No.: 18/017,318

(22) PCT Filed: Jul. 19, 2021
(86) PCT No.: PCT/EP2021/070161

§ 371 Date: Jan. 20, 2023

(30) Foreign Application Priority Data
Jul. 23, 2020 (DE) 10 2020 119 528.1

(51) Int. Cl. H01M 8/18; H01M 8/04186; H01M 8/04082

(52) U.S. Cl. CPC H01M 8/188; H01M 8/04186; H01M 8/04201

(57) ABSTRACT

A redox flow battery, having at least one cell. The at least one a cell is composed of two half-cells and each half-cell has at least one half-cell interior for receiving an electrolyte. The redox flow battery also has at least one electrode and at least one membrane assigned to each cell. The at least one electrode and the at least one membrane are arranged to form a stack. At least one electrode and at least one membrane are at least partially connected in a fluid-tight manner. There is also a method for producing the battery.

### BACKGROUND OF THE INVENTION

### Field of the Invention

The invention relates to a component, in particular for a redox flow battery, having at least one cell, wherein a cell is constructed of two half-cells, with each half-cell having at least one half-cell interior space for receiving an electrolyte, each cell being assigned at least one electrode and at least one membrane, and at least one electrode and at least one membrane being arranged in a stack.

### Description of the Related Art

Components of the type mentioned above are known and are used, for example, in redox flow batteries. Redox flow batteries are used in particular in static applications and are advantageous due to their long cycle lifetime, non-flammability and independent scalability of performance and capacity. Redox flow batteries store energy in liquid electrolytes. For the energy storage process or the energy release process, i.e. the charging and discharging of the battery, the electrolytes circulate through cell stacks, in which the conversion between electrical and chemical energy takes place. The cell stacks, also known as stacks, generally consist of a large number of individual cells electrically connected in series. Typically, a redox flow stack consists of 35 to 40 cells, with each cell consisting of components such as cell frames, electrodes, membranes and sealing elements arranged in between them. The components can be stacked on top of each other and pressed together.

Due to the arrangement of the sealing elements in particular, the assembly of the cell stacks is very time-consuming and therefore expensive. The fluid of the cell stacks, which must prevent mixing of the electrolytes within the cell stacks, is of great importance and represents a major challenge. The cell stacks must also be sealed against leaks to the outside.

In the case of a force-fitting assembly of cell stacks, all components must be stacked on top of each other correctly and in the proper place, wherein the seals in particular must be positioned exactly. During the production of the components used, the tolerances regarding thickness and/or groove depths for sealing rings and other sealing elements must be observed in order to ensure the leak-tightness of the cell stack. For example, solid end plates can be used in the production of the cell stack, through which a screw connection and sealing can be achieved by means of a force-fitting connection.

Alternatively, components for redox flow batteries have been described in which the electrodes and membranes are each connected to the cell frames in a materially-bonded manner, so that sealing elements can be dispensed with, for example, by welding in DE 10 2013 107 516 A1 or by adhesive bonding in DE 10 2015 102 123 A1.

However, the disadvantage of the aforementioned methods is that when assembling the stack, a joining step, for example, welding or gluing, must always take place between each stacking step, which makes the process time-consuming. Furthermore, restrictions in the material selection apply to the welding process, as not all elements from all materials can be welded together. Furthermore, document DE 10 2016 004 027 A1 discloses a cell and a cell stack of a redox flow battery and a method for producing this cell stack. A cell of a redox flow battery comprises at least two cell frame elements, a membrane and two electrodes, wherein at least two cell frame elements, the membrane and the two electrodes enclose two separate half-cell interior spaces. In the at least two cell frame elements, at least four separate channels are provided in such a way that the two cell interior spaces can be permeated by different electrolyte solutions. With the exception of the at least four separate channels, the cell is designed to be fluid-tight. In a process for producing a battery, the at least two cell frame elements, the electrodes and the membrane are placed in a potted housing, and the gap between the cell frame elements, the two electrodes and the membrane is filled with a liquid potting medium, so that all the mentioned components are potted together in a fluid-tight manner. The disadvantage of the potting concept is, for example, that the cell frame is part of the sealing concept and cell frames must therefore be used, which means material requirements apply regarding the adhesion of the potting media to the cell frame.

In other common approaches according to the prior art, the sealing of a half-cell of a cell stack is achieved by the fact that a fluid-tight connection is at least partially formed between electrode and frame and a fluid-tight connection is at least partially formed between frame and membrane. This is carried out, for example, by using sealing elements or by gluing or welding the electrode to the frame and the frame to the membrane. The cell frame is therefore an integral part of the sealing concept.

Furthermore, the cell frames perform the function of defining the distance between the electrode and the membrane and thereby defining the thickness of the half-cell interior space and thus the compression of the felt electrode, assuming a felt electrode is used.

In addition, according to the prior art the cell frame ensures the electrolyte feed as well as the electrolyte discharge in and out of the half-cell interior space and also forms the electrolyte feed line and the electrolyte discharge line. Sealing between the individual elements of the cell stack to form a sealed electrolyte feed line represents a further challenge.

In accordance with the tasks described, requirements are placed on the cell frame, for example with regard to the manufacturing tolerances or with regard to the material properties required for the adhesive bonding or welding. Additional requirements are also placed on the design of the electrolyte feed line and the electrolyte disposal line as well as on the electrolyte feeds and electrolyte discharges. The cell frames are therefore often quite complex elements, which can be demanding and therefore expensive to produce.

### BRIEF SUMMARY OF THE INVENTION

The object of the invention is to propose a component, in particular for a redox flow battery, which enables a time-efficient and cost-efficient construction of a sealed component for a redox flow battery.

The object is achieved with a component having the features of claim 1 and by a method for producing a component having the features of claim 15. Extensions and advantageous embodiments are specified in the dependent claims.

In a component, in particular for a redox flow battery, having at least one cell, wherein a cell is constructed of two half-cells, each half-cell having at least one half-cell interior space for receiving an electrolyte, each cell being assigned at least one electrode and at least one membrane and at least one electrode and at least one membrane being arranged in a stack, it is provided according to the invention that at least one electrode and at least one membrane are at least partially connected in a fluid-tight manner. A component, in particular for a redox flow battery, has at least one cell, preferably a plurality of cells, wherein at least one cell is constructed from two half-cells. Each half-cell has at least one half-cell interior, into which an electrolyte is introduced by means of an electrolyte feed and is discharged by means of an electrolyte discharge. The half-cell interiors are each partially closed off by at least one electrode and at least one membrane. A porous, electrically conductive felt may be arranged in a half-cell interior, so that the surface area for the electrochemical reaction in the half-cell interior is increased. The electrodes and the membranes are essentially flat in shape and have stacking surfaces as well as laterally circumferential side surfaces which bound the stacking surfaces. The stacking surfaces of two components arranged one above the other in a cell stack, i.e. adjacent, face each other, while the side surfaces face outwards. For example, the stacking surfaces may have a rectangular, in particular square, footprint or a round, in particular circular, footprint. In particular in membranes and electrodes with a rectangular footprint, the side surfaces each define a plane, wherein the planes defined by the side surfaces are arranged perpendicular to the planes defined by the stacking surfaces. In the case of membranes and electrodes with round footprints, the outer surface spanned by the side surfaces is arranged perpendicular to the stacking surfaces. For sealing purposes, the at least one electrode and the at least one membrane are at least partially connected in a fluid-tight manner by a fluid-tight connection. By means of the at least partial fluid-tight connection between the membrane and the electrode, a half-cell interior space can be formed between the membrane and the electrode. The fluid-tight connection in this case may be formed, for example, between the stacking surfaces of the electrode and the membrane that face each other. In particular, the fluid-tight connection may be formed in the region of the side edges of the stacking surfaces of the electrode and the membrane arranged on top of one another, in particular parallel to the side edges of the stacking surfaces, so that a half-cell interior space for receiving the electrolyte is formed between the stacking surfaces and the circumferential fluid-tight connection. The fluid-tight connection can be formed, for example, by a materially-bonded connection, for example, by an adhesive bond, a welded joint or similar. Furthermore, it is possible that in order to seal and form a half-cell interior, a membrane and an electrode are at least partially connected in a fluid-tight manner on at least one outward facing side surface. A half-cell interior space is thereby formed by the mutually facing stacking surfaces of the electrode and the membrane as well as the circumferential fluid-tight connection of the side surfaces of the electrode and the membrane. Due to the fluid-tight connection of the membrane to the electrode, it is not necessary to produce a seal, in particular of the half-cell interior spaces, for example by the arrangement of sealing elements and the construction of a force-fitting connection. Sealing elements such as O-rings and their complex assembly can thus be omitted. It is thus possible and advantageous to seal the electrode and the membrane without including cell frames in the sealing design. Instead, the membrane and the electrode can be directly connected to each other in a fluid-tight manner. The cell frames are not required to perform any functions in order to form the fluid-tight connection. If used at all, cell frames can only perform the task of electrolyte feeding and electrolyte discharge and/or the task of forming an electrolyte feed line and/or an electrolyte disposal line, or the function of a spacer between membrane and electrode. Reducing the requirements on the cell frame with the option of eliminating cell frames altogether can reduce costs.

In one embodiment of the invention at least one electrode and at least one membrane are each at least partially connected in a fluid-tight manner, laterally around the circumference. For sealing purposes, the at least one electrode and the at least one membrane are at least partially connected in a fluid-tight manner on at least one outwardly facing side surface. Furthermore, it is possible to produce a fluid-tight connection between the edge regions of the electrode and the membrane, in particular the edge regions of the stacking surfaces facing each other. The fluid-tight connection can be, for example, a materially-bonded or also a force-fitting connection. In particular, between the electrode and the membrane, a half-cell interior space for receiving an electrolyte is formed. Due to the at least partial circumferential fluid-tight connection, it is not necessary, for example by using sealing elements between the components, to establish a force-fitting connection in order to ensure the leak-tightness of the component. The fluid-tight connection of the outward facing side surfaces makes it a simple matter to seal the half-cell interior spaces of a redox flow battery without having to resort to additional sealing elements.

In an extension of the invention, at least one electrode and at least one membrane are each at least partially connected in a fluid-tight manner to at least one side plate around the circumference. A side plate can be a flat component. In particular, when using membranes and electrodes with a rectangular footprint, the side plate can have approximately the same width as the side surfaces of the electrode and the membrane. When using membranes and electrodes with a round footprint, a side plate may be designed to be flexible, for example, so that the side plate is placed around the side surfaces of the membranes and electrodes. In the case of rectangular membranes and electrodes, each side of the membranes or electrodes can be assigned a side plate. In order to produce a fluid-tight connection between the membrane and the electrode, these can be connected, for example at their outward facing side surfaces, to at least one side plate. Between the side surfaces of the electrode and the membrane as well as the side plate, a fluid-tight connection is produced, for example, by a materially-bonded connection, in particular an adhesive bond. In this case, the plane spanned by the side plate is arranged approximately parallel to the planes spanned by the side surfaces of the electrode and the membrane. Furthermore, it is possible to produce a fluid-tight connection between the edge regions of the electrode and of the membrane, in particular the edge regions of the stacking surfaces facing each other and one or more side plates. The use of a side plate enables a particularly simple type of fluid-tight connection, as this can be mounted laterally after the stacking process of the individual components.

In an extension of the invention, at least one fluid-tight connection is a materially-bonded connection. Fluid-tight connections, for example, between an electrode and a membrane, in particular between the edge regions of the stacking surfaces and/or the side surfaces of an electrode and a membrane, or between the side surfaces of an electrode, a membrane and a cell frame or else between an electrode, a membrane, a cell frame and a side plate, in particular between the side surfaces and a side plate, can be produced in a materially-bonded manner.

In one embodiment of the invention, the at least one electrode and the at least one membrane are connected to each other directly in a fluid-tight manner, and by means of the fluid-tight connection the half-cell interior space is at least partially closed and/or the at least one electrode and the at least one membrane are directly connected in a fluid-tight manner to at least one side plate and the half-cell interior space is at least partially closed in a fluid-tight manner by the fluid-tight connections. In contrast to a direct connection of the membrane and the electrode, the indirect connection of electrode and membrane includes a cell frame in the connection, i.e. the indirect connection of membrane and electrode is effected by a direct connection of the membrane and the electrode to the same cell frame. The direct fluid-tight connection of the membrane to the associated electrode forms a sealed, fluid-tight half-cell interior space. The fluid-tight connection between membrane and electrode can be interrupted by electrolyte feed lines and electrolyte discharge lines in order to ensure electrolyte exchange with the half-cell interior space. Further sealing elements, such as rubber seals or similar, are not required for the fluid-tight sealing of the half-cell interior space. In particular, cell frames do not fulfil any of the functions of sealing the half-cell interior space. The fluid-tight connection between membrane and electrode can therefore also be achieved by completely dispensing with cell frames. Cell frames can nevertheless be provided and used, for example, as spacers between the membrane and the electrode for setting a defined distance between the membrane and electrode. Cell frames can also be used to specify the distribution of the electrolytes in the half-cell interior by means of channel structures located in the frames. For example, for this purpose, the electrode and the membrane can overlap the cell frame laterally, so that the cell frame is surrounded laterally by the fluid-tight connection between the membrane and electrode. The fluid-tight connection between the membrane and the electrode can be achieved, for example, by means of an adhesive that connects the membrane directly to the electrode. However, other processes for producing the fluid-tight connection are also possible. The direct fluid-tight connection prevents an electrolyte from one half-cell interior space from entering the adjacent half-cell interior space, for example. The sealing of the half-cell interior spaces by the direct fluid-tight connection of membranes and electrodes creates a very cost-effective sealing method. Furthermore, it can be provided that the electrodes and membranes are directly connected to laterally arranged side plates in a fluid-tight manner. In this case, the fluid-tight sealing of the half-cell interior spaces would be provided by the respective direct fluid-tight connection of the membranes and electrodes to the respective side plates. Here again, there are no sealing requirements on the cell frames or other components. However, cell frames can be provided, for example as spacers or similar. This results in low demands being placed on the material properties of the cell frames, as these do not need to be bonded, for example, to other components for producing fluid-tight connections.

In one embodiment of the invention, at least one at least partially fluid-tight half-cell interior space is formed between the at least one electrode, the at least one membrane and the fluid-tight connection between the membrane and the electrode, and/or at least one at least partially fluid-tight half-cell interior space is formed between the at least one membrane, the at least one electrode and the fluid-tight connections of the membrane and the electrode to at least one side plate. Fluid-tight sealed half-cell interior spaces are necessary in the cell stack so that no electrolyte from one half-cell interior space can enter an adjacent half-cell interior space. The formation of the at least partially fluid-tight half-cell interior space can thus be effected, for example, solely by the membrane, the electrode, as well as the direct fluid-tight connection between the membrane and the electrode. The fluid-tight connection between membrane and electrode can be interrupted by electrolyte feed lines and electrolyte discharge lines in order to ensure electrolyte exchange with the half-cell interior space. Additional components for forming the half-cell interior space are not necessary. In particular, cell frames can be arranged in the half-cell interior space, for example as spacers or similar, but do not contribute to the sealing effect. It is also possible that a half-cell interior space is formed between the electrode, the membrane, the side plates assigned to the electrode and the membrane and between the direct fluid-tight connections of the membrane to the side plates and the electrode to the side plates. The fluid-tight half-cell interior space is thus produced solely by these components and their fluid-tight connection.

In an extension of the invention, at least one materially-bonded connection is an adhesive bond. Materially-bonded connections, for example, between a membrane and an electrode, in particular between the edge regions of the stacking surfaces and/or the side surfaces of an electrode and a membrane, or also between a membrane, an electrode, a cell frame and a side plate, in particular between the side surfaces of the components and a side plate, can be produced in a simple manner by adhesive bonds. For example, the adhesive to be used can be applied to a side plate and thus the fluid-tight adhesive bond between the side plate and the edge regions of the electrode and the membrane, in particular the edge regions of the stacking surfaces facing each other and/or the side surfaces of the components, can be produced in a very time-efficient manner.

In one embodiment of the invention, at least one materially-bonded connection is a welded joint. Welding can be used to connect the components in a fluid-tight manner. This enables particularly secure and accurate fluid-tight connections to be made between the components or between the components and the side plates.

In an extension of the invention, at least one half-cell has at least one cell frame and at least one cell frame is stacked with at least one membrane and with at least one electrode. The cell frame is a frame-shaped component, which at least partially surrounds a cavity, in particular for receiving an electrolyte. One possible arrangement can therefore consist of the sequence of the electrode, the cell frame, and the membrane. The typical structure of a cell consisting of two half-cells would be, for example, an electrode followed by a cell frame filled with a first electrolyte, a membrane to which a second cell frame with a second electrolyte is connected, followed by another electrode. The fluid-tight sealing of the half-cell can be ensured by the fluid-tight connection of the electrode and the membrane, so that the cell frame acts as a spacer between the membrane and the electrode and provides the functions of electrolyte feed and electrolyte discharge. The footprint of the membrane and the footprint of the electrode, i.e. the stacking surfaces, can project laterally from the footprint of the cell frame. In contrast to the prior art, the cell frame does not have the property of being an integral part of the sealing concept, in particular, the cell frame is not integrated in the fluid-tight connection between the electrode and membrane. In one embodiment, the cell frame can have lateral protrusions that project beyond the footprints of the membrane and the electrode. In the stacked sequence of the membrane, the cell frame, and the electrode, the lateral protrusions can project beyond the edges of the membranes and the electrodes. Conduit structures may be formed in the lateral protrusions, through which the electrolyte feed and the electrolyte discharge for the half-cell interior can be formed. The fluid-tight connection of the half-cell interior is thus formed partially by the direct fluid-tight connection of the side regions of the membranes and the electrodes. In the regions where the lateral protrusion of the cell frames with the electrolyte feeds or electrolyte discharges projects beyond the edge regions of the membranes and the electrodes, there is no direct fluid-tight connection between the membrane and the electrode and nor is one required for correct functioning. Each cell frame has two protrusions, one for the electrolyte feed and one for the electrolyte discharge. The protrusions of the cell frames of two adjacent half-cells are arranged offset from each other, so that, for example, the protrusions with electrolyte feeds of every second half-cell in a cell stack are arranged substantially congruently in a top view. An electrolyte conduit element is arranged above the lateral protrusions of the frame elements, arranged one above the other in a stacked arrangement, i.e. in a cell stack. The electrolyte feeds of multiple half-cells of the same polarity are supplied with electrolyte via an electrolyte conduit element. Similarly, the electrolyte is discharged via a further electrolyte conduit element, which combines the electrolyte discharges of multiple half-cells of the same polarity. The electrolyte conduit elements can be arranged in each case across the electrolyte feed or the electrolyte discharges of all half-cells of a stack or only across a certain number of half-cells to reduce short-circuit currents. The electrolyte conduit elements can be essentially formed in the manner of a housing and can be fitted over the lateral projections of the cell frames. At the edges of the electrolyte conduit elements, these are sealed onto the fluid-tight connections of the membranes and electrodes. This prevents the electrolyte from escaping from the electrolyte conduit element.

In an extension of the invention, at least one electrode, at least one membrane and at least one cell frame are each at least partially connected to at least one side plate in a fluid-tight manner, in each case laterally on at least one outward facing side surface. In a possible layer sequence, a membrane, a cell frame and an electrode can be stacked, wherein the electrode, the cell frame and the membrane can be connected in a fluid-tight manner at their side surfaces. By connecting the outward facing side surfaces, a fluid-tight closure of a half-cell is achieved, in particular the half-cell interior space, or of an entire cell stack in the case a plurality of consecutive components.

In an extension of the invention, at least one electrode, at least one membrane and at least one cell frame are each at least partially connected to at least one side plate in a fluid-tight manner, in each case laterally on at least one outward facing side surface. The component sequence of a half-cell, consisting for example of an electrode, a cell frame and a membrane, wherein one electrode and one membrane can be assigned to two half-cells, can be connected to each other in a fluid-tight manner by attaching a side plate. In this case, the electrodes, cell frames and membranes stacked on top of each other are connected to at least one side plate in a fluid-tight manner on the outward facing side surfaces. In particular, the membranes, the electrodes and the cell frames of a cell stack can be connected laterally with their four side surfaces to one side plate each in a fluid-tight manner. For example, a materially-bonded connection can be produced between a side plate and the stacked components, i.e. the membranes, the cell frames and the electrodes. The use of side plates, in particular on the four side surfaces of the components, provides a simple way of producing a time-efficient fluid-tight connection of the components.

In one embodiment of the invention, at least one electrode, at least one cell frame and at least one membrane are each at least partially connected in a fluid-tight manner to at least one side plate, laterally on four side surfaces. At least one electrode, at least one cell frame and at least one membrane with a rectangular footprint of the stacked components of a cell stack, preferably all components of a cell stack, are connected in a fluid-tight manner to a side plate on their four side surfaces, each of which bounds the square stacking surface. A cell stack can thus have four side plates, wherein two adjacent side plates together can enclose an angle of approximately 90°. By means of four side plates, which are connected to the side surfaces of the components, a complete fluid-tight sealing of the cell stack can therefore be carried out.

In an extension of the invention, at least one half-cell interior space is assigned at least one electrolyte feed and/or at least one electrolyte discharge, and at least one electrolyte feed and/or at least one electrolyte discharge is formed by at least one opening in at least one fluid-tight connection formed between at least one membrane and at least one electrode. Cells can consist of two half-cells, each half-cell having a half-cell interior space for receiving an electrolyte. In order to ensure the flow of the electrolyte through the half-cell interior space, a half-cell has an electrolyte feed and an electrolyte discharge. The electrolyte feeds or electrolyte discharges can be connected to electrolyte conduits, which lead to an electrolyte supply, i.e. an electrolyte reservoir. Between a membrane and an electrode, for example between the edge regions of the mutually facing stacking surfaces of the membrane and the electrode, an at least partial fluid-tight connection is formed surrounding the half-cell interior space. In particular, for example, a materially-bonded connection can be produced between the membrane and the electrode and thus a half-cell interior space can be formed between the membrane and the electrode. The electrolyte feeds and the electrolyte discharges can be formed in particular by openings or cavities in the fluid-tight connection of the membranes and the electrodes. The cavities ensure the electrolyte feed and/or the electrolyte discharge to the half-cell interior space. Thus, an electrolyte supply to the half-cell interior spaces of the half-cells is made possible in a particularly simple manner. For example, the fluid-tight connection can be formed by an adhesive bond. The electrolyte feeds and the electrolyte discharges can be formed by cavities in the adhesive material mass.

In an extension of the invention, a half-cell has at least one electrolyte feed and/or one electrolyte discharge, and at least one electrolyte feed and/or at least one electrolyte discharge are each at least partially formed by at least one cavity in a cell frame and a passage opening arranged laterally in a cell frame. The cell frames of a half-cell can at least partially form the half-cell interior of the half-cell in which the electrolyte is received, wherein the fluid-tight sealing of the half-cell interior spaces can be effected by the fluid-tight connection of the membrane to the electrode. In order to allow the electrolyte to circulate, a cell frame has lateral passage openings, which are connected by a cavity in the cell frame to the interior of the cell frame, the half-cell interior space. Electrolyte can be passed through the half-cell interior spaces through the cavities in the cell frame and the passage openings. The passage openings and the cavities in the cell frames are aligned in such a way as to allow a fluid flow through the cavities in the cell frames and the openings of the fluid-tight connection between the membrane and the electrode. Thus, an electrolyte can enter the half-cell interior space through the opening in the fluid-tight connection and the cavity in the cell frame.

In an extension of the invention, the cavity narrows starting from the width of the half-cell interior space in the direction of the lateral passage opening. A cell frame of a half-cell can be constructed in the shape of a frame and can partially surround a half-cell interior space. In particular, the half-cell interior space is partially bounded by the inner sides of the cell frame, i.e. the inwardly facing side surfaces of the frame. The cavity, through which the electrolyte feeds or electrolyte discharges are partially formed, narrows from the width of the half-cell interior space in the direction of the passage openings arranged on the outer side surfaces. In particular, the cavities of a cell frame, one of which forms sections of the electrolyte feed and one of which forms sections of the electrolyte discharge, can be arranged in frame sections of the cell frame oriented parallel to one another. The cavities of the electrolyte feed and the electrolyte discharge narrow in the direction of the outward facing side surfaces. The cavities are thus at least partially funnel-shaped, wherein the funnel openings are arranged facing each other. By widening or narrowing the cavities starting from the passage openings, an efficient flow through the half-cell interior space by the electrolyte is possible.

In one embodiment of the invention, at least one half-cell has at least one electrolyte feed and/or at least one electrolyte discharge, a cell frame is formed by at least two cell frame elements and at least one electrolyte feed and/or at least one electrolyte discharge is formed at least partially by at least one free space between at least two cell frame elements. A cell frame of a half-cell can be formed by cell frame elements. Thus, a cell frame can be formed in particular in two parts. In this case, a cell frame element may comprise at least one frame limb and at least one limb section arranged at right angles to it. For example, a cell frame element may be L-shaped, wherein a right angle is enclosed between a frame limb and a frame limb section. In order to form a cell frame, two such cell frame elements can be arranged, for example, in such a way that the frame limbs are each arranged parallel to each other and the limb sections are arranged parallel to each other, so that, for example, a rectangular shape of the cell frame can be obtained. Between a limb section of the one cell frame element and a frame limb of the other cell frame element, a clearance may exist so that the cell frame elements do not touch. Due to the free space between the cell frame elements, an electrolyte feed or an electrolyte discharge can be formed in some sections. The clearance between the cell frame elements thus allows an electrolyte to be introduced into the half-cell interior space and discharged again. In this case, the clearances are aligned in such a way that an electrolyte flow is possible through the opening in the fluid-tight connection between the membrane and the electrode into the half-cell interior space. The limb sections can be designed in such a way that in some sections the free space between the cell frame elements is funnel-shaped, so that the electrolyte feed or electrolyte discharge formed by the free space opens out in the direction of the half-cell interior space. By forming the electrolyte feeds or electrolyte discharges by means of a free space between the cell frame elements, the circulation of an electrolyte through the half-cell interior is enabled in a particularly simple manner.

In an extension of the invention, at least one half-cell has at least one electrolyte feed and/or at least one electrolyte discharge, and at least one electrolyte discharge and at least one electrolyte feed is formed by at least one passage opening in at least one side plate. A half-cell preferably has one electrolyte feed and one electrolyte discharge. The electrolyte feed and electrolyte discharge allow the electrolyte to circulate through the half-cell interior space of the half-cell. The membranes and electrodes of a half-cell or a cell may be connected to a side plate laterally on their outward facing side surfaces. In order to ensure an electrolyte feed or electrolyte discharge, the side plate may have passage openings through which the electrolyte can enter the half-cell interior space. For example, the passage openings in the side plates can be connected to feed lines or discharge lines for the electrolyte.

In an extension of the invention, at least one electrolyte feed is connected to at least one electrolyte feed line and at least one electrolyte discharge is connected to at least one electrolyte discharge line, and at least one electrolyte feed line and/or at least one electrolyte discharge line extends outside the stacking surfaces of the electrode and/or the stacking surface of the membrane and/or the stacking surfaces of the cell frames. Preferably, each half-cell has an electrolyte feed and an electrolyte discharge to allow the electrolyte to pass through the half-cell interior space. The electrolyte feeds of the half-cells are connected to electrolyte feed lines, the electrolyte discharges of the half-cells are connected to electrolyte discharge lines. Through the electrolyte feed lines and electrolyte discharge lines, the half-cell interior spaces are each connected to an electrolyte reservoir via the electrolyte feeds and electrolyte discharges. It is possible to implement the formation of electrolyte supply lines and/or disposal lines outside of the cell frames and thus to further reduce the demands on the cell frames and simplify the process of producing the fluid-tight connections. The electrolyte feed lines or electrolyte discharge lines are arranged such that they extend outside of the stacking surfaces of the membrane and/or the electrode and/or the cell frame. The electrolyte lines therefore do not intersect the outer side surfaces of the membrane, the electrode or the cell frame that run perpendicular to the stacking surfaces, or the plane spanned by the side surfaces. For example, the electrolyte feed lines and electrolyte discharge lines may be tubing lines that can be located outside of the stacking surfaces. The arrangement of the feed and discharge lines outside of the stacking surfaces enables a particularly simple construction of a redox flow battery and thus a particularly simple assembly, since the formation of the electrolyte feed line and electrolyte discharge line is not implemented by means of the stacked cell frames. Thus, the electrolyte feed line and electrolyte discharge line can be formed temporally and functionally separately from the construction of the fluid-tight connection between membrane and electrode.

In an extension of the invention at least one electrolyte feed line and/or at least one electrolyte discharge line is formed in each case by at least one cavity in at least one side plate. The membranes and electrodes of a cell, or the membranes, the electrodes and the cell frames of a cell, can be connected to a side plate around the circumference in a fluid-tight manner, for example on their outward facing side surfaces. In order to enable a fluid flow between the half-cell interior spaces, electrolyte feed lines and/or electrolyte discharge lines, which connect the electrolyte feeds and electrolyte discharges of the half-cell to each other, may be formed by cavities in the side plates. In particular, the side plates may have inner channels positioned in each case for connection to the electrolyte feed and electrolyte discharge, so that a fluid-tight connection to the outside is provided. Furthermore, the side plates may have open channels, in particular grooves, pockets or the like, on their inward facing side surfaces, that is, on the side surfaces connected to the side surfaces of the membranes and electrodes, which can serve as feed lines and discharge lines. In this case, the feed and discharge lines are partially formed by the side plates and partially by the side surfaces of the membranes and electrodes. The formation of electrolyte feed lines and electrolyte discharge lines through the side plates enables a very time-efficient and cost-effective assembly of the electrolyte feed lines and electrolyte discharge lines.

In one embodiment of the invention, at least one electrolyte feed line and/or at least one electrolyte discharge line are arranged outside of the side plates. The electrolyte feeds and electrolyte discharges can be formed by passage openings in the side plates. The passage openings in the side plates can be connected by tubing lines, for example, so that a particularly simple assembly of the electrolyte feeds and electrolyte discharges is enabled.

In one embodiment of the invention, at least one cell frame has at least one electrolyte feed and/or at least one electrolyte discharge, and at least one cell frame at least partially forms at least one electrolyte feed line and/or at least one electrolyte discharge line and the at least one electrolyte feed and/or the at least one electrolyte discharge is connected in a fluid-tight manner to the electrolyte feed line and/or to the electrolyte discharge line. The half-cell interior of a half-cell may be partially formed by the inner sides of a cell frame, wherein the half-cell interior is closed at the top and bottom by a membrane and an electrode. In order to enable the supply of the half-cell interior with an electrolyte, the cell frame has at least one electrolyte feed and/or an electrolyte discharge. The electrolyte feeds and electrolyte discharges can be formed by openings, in particular on the inner side, i.e. the side of the cell frame elements that faces the half-cell interior space. Electrolyte feeds and electrolyte discharge lines are each connected to electrolyte feed and electrolyte discharge lines. The electrolyte feed lines may be formed by cavities in the cell frame. In particular, the electrolyte feed lines may be formed by cavities, in particular by closed channels, which extend perpendicular to the stacking surface of the cell frame element. Since the membranes and electrodes protrude laterally beyond the cell frame and the fluid-tight sealing of the half-cell interiors is effected via the connection of the membranes and electrodes to each other, corresponding openings in the membranes and electrodes are provided in order to form the electrolyte conduits. Due to the stacked arrangement of the frame elements, the membranes and the electrodes, as well as the identical arrangement of the openings provided for the electrolyte feed lines, an electrolyte feed line extending over an entire cell stack can be formed. The fluid-tight connection of the membrane and the electrode in this case can be effected, for example, by means of a circumferential fluid-tight connection to the side surfaces of the membrane and the electrode. Furthermore, the fluid-tight connection of the side surfaces to side plates can also be provided, so that a cell stack composed of the components is sealed to the outside in a fluid-tight manner. Fluid-tight connections must also be produced between the openings in the cell frames, membranes and electrodes so that a sealed electrolyte feed line is formed. This seal can be effected, for example, with O-rings or similar sealing materials.

A further aspect of the invention relates to a method for producing at least one component, in particular for a redox flow battery, having at least one cell, wherein a cell is constructed of two half-cells, each half-cell having at least one half-cell interior space for receiving an electrolyte, each cell being assigned at least one electrode and at least one membrane and at least one electrode and the electrodes and at least one membrane being arranged in a stack, in which method it is provided according to the invention that at least one electrode and at least one membrane are connected in a fluid-tight manner. To produce a component for a redox flow battery, in particular to produce a cell stack of a redox flow battery, electrodes and membranes are stacked to form half-cells. Each half-cell has a half-cell interior space, which can be formed at least partially between an electrode and a membrane. For the production of a cell stack, electrodes and membranes are stacked and the electrodes and membranes are connected at least partially in a fluid-tight manner. By means of the fluid-tight connection of the electrodes and the membranes, in particular in the edge regions of the electrodes and membranes, a half-cell interior can be formed. In particular, a half-cell interior space is at least partially formed by the mutually facing stacking surfaces of the electrode and the membrane as well as by the fluid-tight connection between the membrane and the electrode. The fluid-tight connection can be produced, for example, between the edge regions of the mutually facing stacking surfaces. In particular, the fluid-tight connection can be arranged parallel to the edge regions of the stacking surfaces, so that a half-cell interior space is formed by the mutually facing stacking surfaces and the circumferential, fluid-tight connection. Furthermore, it is possible that the fluid-tight connection is formed between the outward facing side surfaces of the membrane and the electrode. The fluid-tight connection between all membranes and electrodes of a cell stack can be formed in a directly following step after stacking the elements of a cell stack. It is therefore not necessary to insert a sealing element and/or to carry out a joining process (e.g. welding) between each stacking step. Thus, the invention allows cell stacks to be produced more easily and faster and thus more cost-effectively.

In one extension of the method at least one electrode and at least one membrane are each at least partially connected to each other in a fluid-tight manner, laterally around the circumference. The electrodes and the membranes are essentially flat in shape and have stacking surfaces as well as laterally circumferential side surfaces which bound the stacking surfaces. The stacking surfaces of two membranes and electrodes arranged one above the other, i.e. adjacent, in a cell stack are facing each other, while the side surfaces are oriented facing outwards. The side faces are preferably aligned such that the side faces of the membranes and electrodes lie in a plane. In order for a half-cell interior space to be formed between an electrode and a membrane, the membrane and the electrode can be connected to each other in a fluid-tight manner, for example on their outward facing side surfaces. Furthermore, it is possible to produce a fluid-tight connection between the edge regions of the electrode and the membrane, in particular the edge regions of the stacking surfaces facing each other. The fluid-tight connection can be formed, for example, by a materially-bonded connection. The fluid-tight connection of a membrane and an electrode allows a sealed half-cell interior space to be formed in a simple manner for receiving an electrolyte, without the need for specially designed components.

In an extension of the method at least one electrode and at least one membrane are each at least partially connected to each other in a fluid-tight manner, laterally around the circumference. The electrodes and membranes are connected to at least one side plate in a fluid-tight manner. In particular, the electrodes and membranes are each at least partially connected to at least one side plate in a fluid-tight manner, laterally on at least one outward facing side surface. For example, in electrodes and membranes with a rectangular footprint, the four outward facing side surfaces of the electrodes and the membranes are each connected to a side plate, so that a cell stack is closed off in a fluid-tight manner by four laterally mounted side plates. Furthermore, the membrane and the electrode can be connected in a fluid-tight manner to at least one side plate on their stacking surfaces, in particular on the mutually facing stacking surfaces. The edge regions of the opposite sides of the stacking surfaces can be connected to the side plate in a fluid-tight manner, for example, in a materially-bonded manner. The fluid-tight connection of a membrane, an electrode and the side plates enables a half-cell interior space for receiving an electrolyte to be formed in a simple manner.

In an extension of the method, at least one half-cell interior space has at least one electrolyte feed and/or at least one electrolyte discharge, and at least one electrolyte feed and/or at least one electrolyte discharge is formed by at least one opening in at least one fluid-tight connection formed between at least one membrane and at least one electrode. To form a half-cell interior space, an electrode and a membrane are connected to each other circumferentially in a fluid-tight manner. Between the stacking surfaces of the electrode, the membrane and the fluid-tight connection, the half-cell interior space for receiving the electrolyte is thus formed. In order to enable the electrolyte to be fed into and discharged out of the half-cell interior space, an electrolyte feed and/or an electrolyte discharge, in particular in the form of a cavity, is introduced into the fluid-tight connection. For example, the electrolyte supply or the electrolyte discharge can be introduced into the fluid-tight connection by a machining process, for example by drilling, milling or the like. If the fluid-tight connection is produced by means of an adhesive material, before applying the adhesive material, placeholders can also be arranged at the positions where the cavities for forming the electrolyte supply and/or the electrolyte discharge will later be located. The placeholders can be removed to expose the cavity.

In an extension of the method, each half-cell has at least one cell frame, at least one half-cell interior space is at least partially formed by at least one cell frame, and at least one cell frame, at least one membrane, and at least one electrode are arranged in a stack. Sections of the cell interiors of the half-cells of a cell stack can be formed by cell frames as well as by the stacking surfaces of the membrane and the electrode. In particular, an electrode, a cell frame and a membrane can be stacked to produce a half-cell, wherein the fluid-tight sealing of a half-cell interior space can be effected by the fluid-tight connection of the electrode and the membrane.

In an extension of the method, at least one electrode, at least one membrane and at least one cell frame are at least partially connected in a fluid-tight manner, in each case laterally on at least one outward facing side surface. For the production of a fluid-tight seal of the half-cell interior space, an electrode, a membrane and a cell frame are connected in a fluid-tight manner at their outward facing side surfaces.

In an extension of the method, at least one electrode, at least one membrane and at least one cell frame are each at least partially connected to at least one side plate in a fluid-tight manner, laterally on at least one outward facing side surface. The electrodes, the membranes and the cell frames of a cell stack can be connected in a fluid-tight manner to at least one side plate with their outward facing side surfaces. In the case of membranes and electrodes with rectangular footprints, one side plate is preferably assigned to each of the four side surfaces, so that a cell stack is laterally surrounded by four side plates. The connection of the components by means of side plates creates a very cost- and time-efficient means of forming a fluid-tight connection.

In one embodiment of the method, at least one fluid-tight connection is produced by a materially-bonded connection. The use of a materially-bonded connection, such as welding or adhesive bonding, ensures a secure fluid-tight connection that can be rapidly produced.

In one embodiment of the invention, at least one fluid-tight connection is produced by means of an adhesive bond. A fluid-tight connection of the membranes to the electrodes, or a connection of the components to a side plate, can be effected in a simple manner by means of an adhesive bond. In particular when side plates are used, a connection to the side surfaces of the components of the cell stack can be implemented by applying an adhesive material to the inner sides of the side surfaces.

In an extension of the invention, at least one fluid-tight connection is produced by a welded joint. Welded joints can be used to produce a fluid-tight connection, for example, of the side surfaces of the membranes and the electrodes. The production of fluid-tight joints by means of welded joints makes particularly safe and precise connections possible.

In an extension of the invention, the stacked cell frames and/or membranes and/or electrodes are mechanically removed laterally in a congruent manner. After stacking the components required for a cell stack, these can be mechanically removed laterally to create a side surface that is as flat and congruent as possible. The mechanical removal, for example by means of machining processes, enables particularly precise and easily executed connections of the side surfaces of the components.

### BRIEF DESCRIPTION OF THE DRAWINGS

In the following the invention is explained in more detail based on an exemplary embodiment shown in the drawing. Taken individually, the schematic drawings show:

FIG. 1: a cell stack consisting of membranes and electrodes which are connected together in a fluid-tight manner;

FIG. 2: a cell stack with openings in the fluid-tight connections;

FIG. 3: a cell stack consisting of components according to the invention in a cross-sectional representation;

FIG. 4: a cell stack with electrolyte lines formed by the side plates;

FIG. 5: a cell frame in a cross-sectional representation.

FIG. 6a: membrane and electrode with a fluid-tight connection between the stacking surfaces;

FIG. 6b: membrane and electrode with a fluid-tight connection between the side surfaces;

FIG. 6c: membrane and electrode with fluid-tight connection of the side surfaces to side plates;

FIG. 6d: electrode and membrane with fluid-tight connection of the stacking surfaces to side plates, and

FIG. 7: a cell frame having lateral protrusions, arranged between a membrane and an electrode.

### DETAILED DESCRIPTION

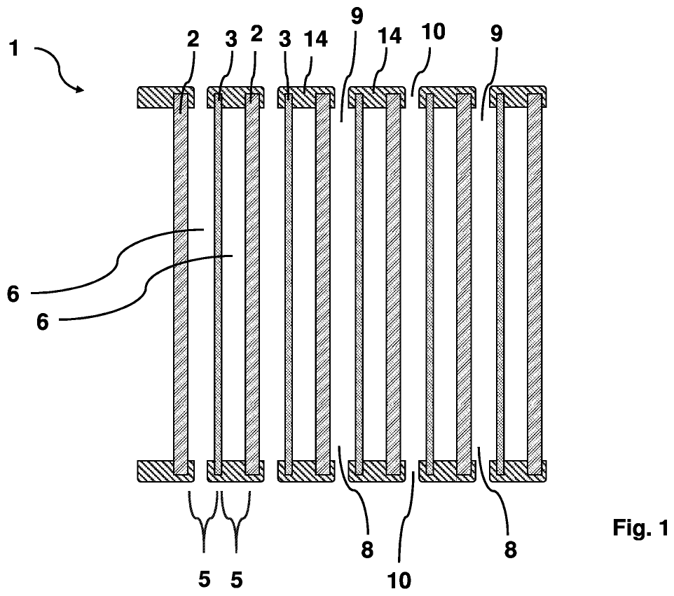

FIG. 1 shows a cell stack 1 consisting of electrodes 2 and membranes 3 in cross-section. An electrode 2 and a membrane 3 are stacked to form a half-cell 5, wherein a membrane 3 and an electrode 2 are each assigned to two half-cells 5. The half-cells 5 each have a half-cell interior space 6, wherein a half-cell interior space 6 is surrounded by the membrane 3 and the electrode 2. A half-cell interior space 6 is designed for receiving an electrolyte. The electrodes 2 and the membranes 3 are connected to each other in a fluid-tight manner. The fluid-tight connection 14 of the electrodes 2 and of the membranes 3 results in a fluid-tight structure of the cell stack 1, wherein no electrolyte can pass accidentally from one half-cell 5 into another half-cell 5. In order to enable electrolyte circulation, electrolyte feeds 8 and electrolyte discharges 9 are provided, so that an electrolyte can be conducted through the half-cell interior spaces 6. Accordingly, passage openings 10 are formed in the fluid-tight connections 14 between the electrodes 2 and the membranes 3, through which the electrolyte can pass. For example, electrolyte feed lines and electrolyte discharge lines can be connected to the passage openings 10.

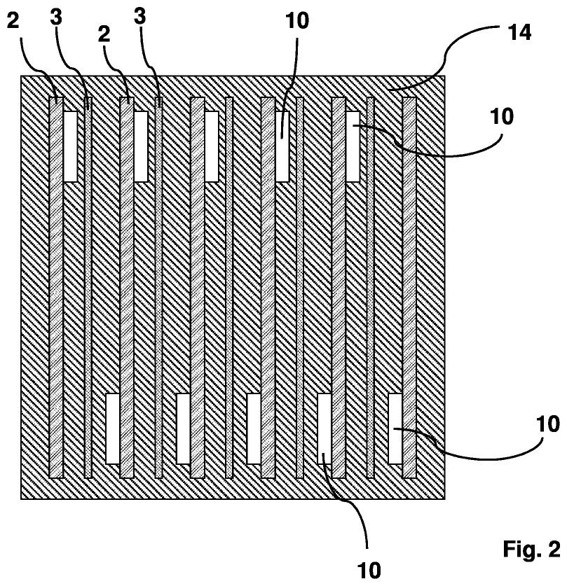

In FIG. 2, a cell stack 1 consisting of electrodes 2 and membranes 3, which are connected to each other by fluid-tight connections 14, is shown in a cross-sectional view. In the fluid-tight connections 14, passage openings 10 are arranged, which enable electrolyte circulation through the half-cell interior spaces 6.

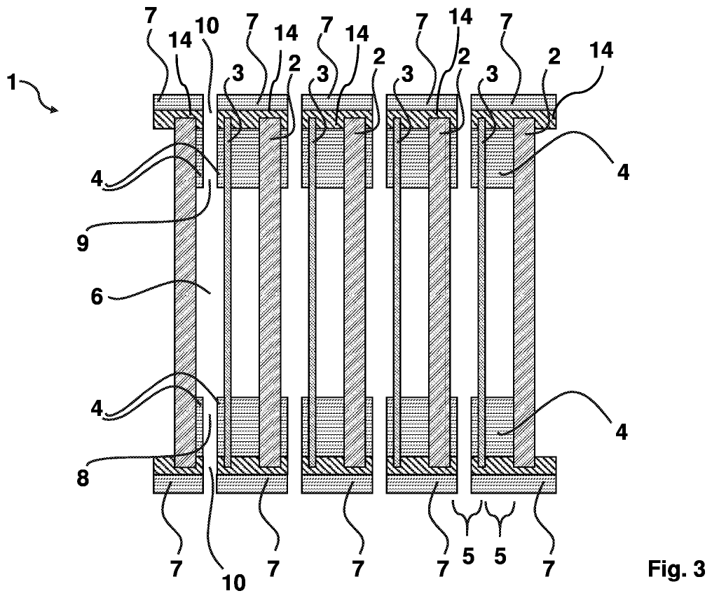

FIG. 3 shows a cell stack 1 having electrodes 2, membranes 3 and cell frames 4, in cross-section. An electrode 2, a membrane 3 and a cell frame 4 are stacked to form a half-cell 5, wherein a membrane 3 and an electrode 2 are each assigned to two half-cells 5. The half-cells 5 each have a half-cell interior space 6, wherein a half-cell interior space 6 is surrounded by the cell frames 4, the membrane 3 and the electrode 2. A half-cell interior space 6 is designed for receiving an electrolyte. The outward facing side surfaces 15 of the electrodes 2, the side surfaces 16 of the membranes 3 and the side surfaces 17 of the cell frames 4 are connected to side plates 7 with a fluid-tight connection 14. The fluid-tight connection 14 of the side plate 7 to the components of the cell stack 1, i.e. to the electrodes 2, the membranes 3 and the cell frames 4, results in a fluid-tight structure of the cell stack 1, wherein no electrolyte can accidentally pass from one half-cell 5 into another half-cell 5. In order to enable electrolyte circulation, the cell frames 4 are provided with electrolyte feeds 8 and electrolyte discharges 9 with passage openings 10, so that an electrolyte can be conducted through the half-cell interior spaces 6. Accordingly, the side plates 7 have passage openings 10 through which the electrolyte can pass. For example, electrolyte feed lines 18 and electrolyte discharge lines 19 can be connected to the passage openings 10.

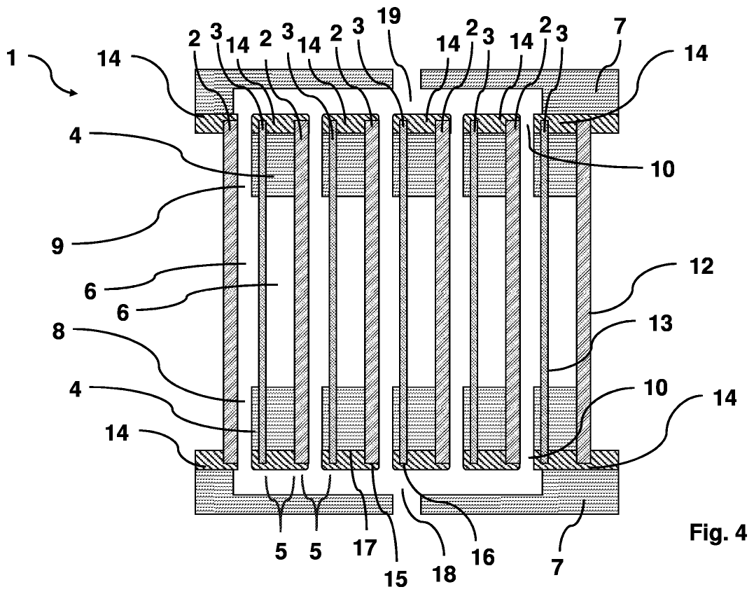

FIG. 4 shows a cell stack 1 having electrodes 2, membranes 3 and cell frames 4, in cross-section. Equivalent parts are labelled with the same reference signs. The electrodes 2, membranes 3 and the cell frames 4 are connected laterally and circumferentially with fluid-tight connections 14 to form half-cell interior spaces 6. For supplying the half-cell interior spaces 6, electrolyte supply lines 18 and electrolyte discharge lines 19 are provided in the side plates 7. The electrolyte conduits 18, 19 can be formed by grooves in the side plates 7, for example. The electrolyte can flow through conduits 18 and 19 into the half-cell interior spaces 6 and be discharged again in the same way.

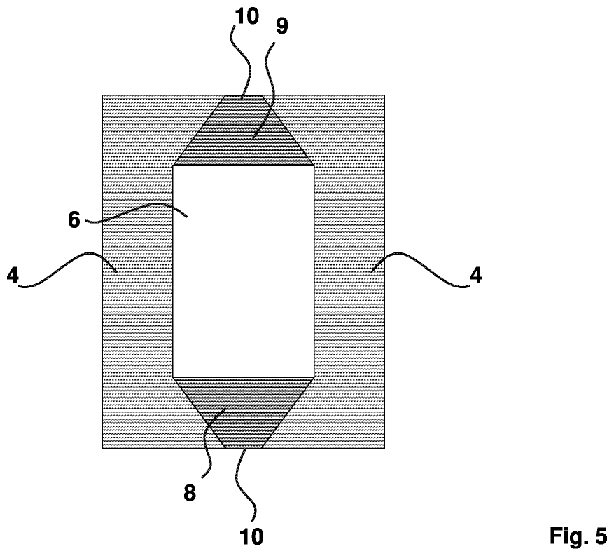

FIG. 5 shows a cell frame 4 with a half-cell interior space 6 in a sectional view. The half-cell interior space 6 is designed for receiving an electrolyte. For supplying and discharge an electrolyte, the cell frame 4 has an electrolyte feed 8 and an electrolyte discharge 9. The electrolyte feed 8 and the electrolyte discharge 9 each have a passage opening 10, which is arranged in each case in an outward facing side surface of the cell frame 4. The electrolyte supply 8 and the electrolyte discharge 9 widen from the passage openings 10 in the direction of the half-cell interior space 6. This enables a uniform flow of an electrolyte through the half-cell interior space 6.

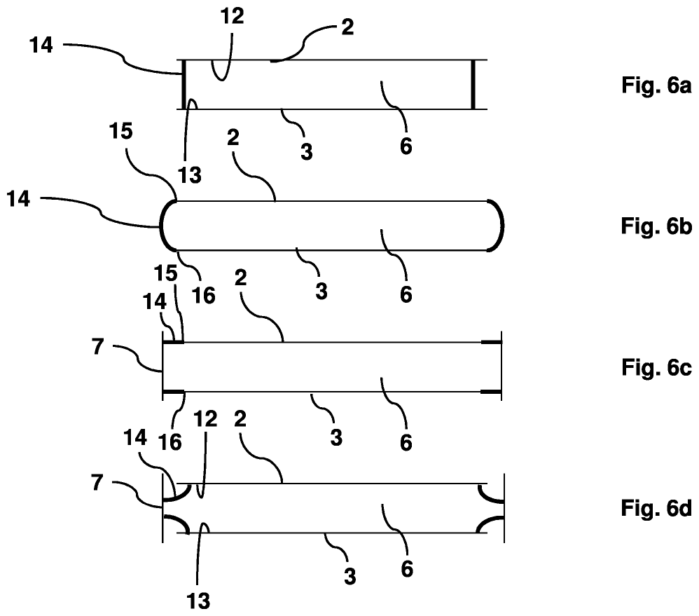

FIG. 6a shows an electrode 2 with a stacking surface 12 and a membrane 3 with a stacking surface 13. The side regions of the stacking surface 13 and the stacking surface 12 are connected to each other by a fluid-tight connection 14. The fluid-tight connection 14 may be in particular a materially-bonded connection, for example a welded joint or an adhesive bond. The fluid-tight connection 14 formed on the side regions of the stacking surfaces 12 and 13 and the mutually facing stacking surfaces form a half-cell interior space 6 for receiving an electrolyte.

FIG. 6b shows an electrode 2 with side surfaces 15, and a membrane 3 with side surfaces 16. The outward facing side surfaces 15 and 16 are connected to each other by means of a fluid-tight connection 14. The fluid-tight connection 14 between the membrane 3 and the electrode 2 and the mutually facing stacking surfaces 12, 13 thus form a half-cell interior space 6, which is intended to receive an electrolyte.

FIG. 6c shows an electrode 2 and a membrane 3. The side surfaces 15 of the electrode and the side surfaces 16 of the membrane are connected to side plates 7 by means of a fluid-tight connection 14. By means of the fluid-tight connection 14 of the electrode 2 and the membrane 3 to the side plates 7, a half-cell interior space 6 is formed between the electrode 2 and the membrane 3 for receiving an electrolyte.

FIG. 6d shows a membrane 3 and an electrode 2. The electrode 2 has a fluid-tight connection 14 to a side plate 7 in each of the edge regions of its stacking surface 12. Likewise, the membrane 3 has a fluid-tight connection 14 to the side plates 7 in the edge regions of its stacking surface 13. The fluid-tight connection 14 to the side plates 7 as well as to the mutually facing stacking surfaces 12, 13 forms a half-cell interior space 6 for receiving an electrolyte.

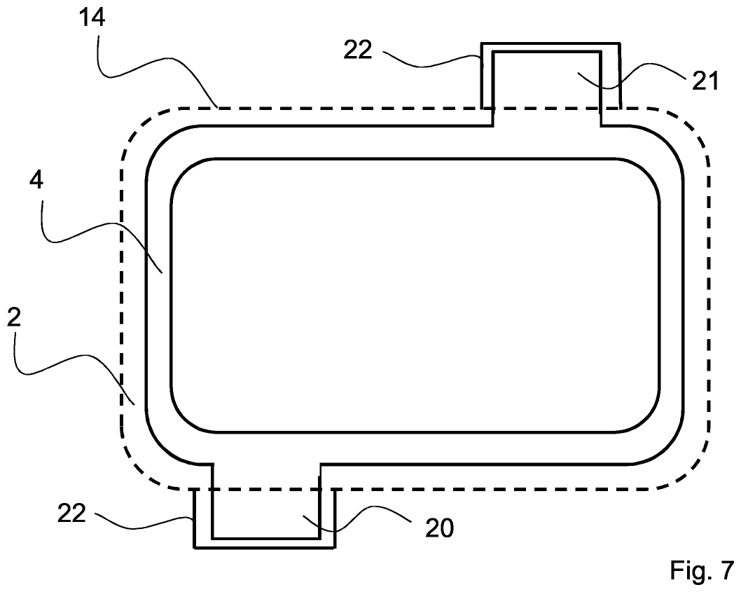

In FIG. 7, a cell frame 4 with lateral protrusions 20, 21 is shown, wherein the cell frame 4 is arranged between an electrode 2 and a membrane 3. The electrode 2 and the membrane 3 have fluid-tight connections 14 in their edge regions, which are interrupted only by the lateral protrusions 20, 21 of the cell frame 4. The lateral protrusion 20 forms an electrolyte supply 8 and the lateral protrusion 21 forms an electrolyte discharge 9. The lateral protrusions 20, 21 of two adjacent half-cells are arranged offset from each other. The lateral protrusions 20 and 21 of the cell frames of the half-cells, which are permeated by the same electrolyte, are here arranged underneath each other, i.e. congruently in a top view. Via the congruent lateral projections 20 or 21 of the half-cells in the cell stack, an electrolyte conduit element 22 can be arranged so that the same electrolyte is supplied to or discharged from the corresponding half-cells.

All the above mentioned features referred to in the above description are in the claims can be combined in any permutation with the features of the independent claim. The disclosure of the invention is therefore not limited to the feature combinations described or claimed, rather all meaningful feature combinations are to be considered as disclosed in the context of the invention.

1. A redox flow battery, having at least one cell, wherein a cell is constructed of two half-cells, with each half-cell having at least one half-cell interior space for receiving an electrolyte, each cell being assigned at least one electrode and at least one membrane, and at least one electrode and at least one membrane being arranged in a stack, wherein at least one electrode and at least one membrane are at least partially connected in a fluid-tight manner.

2. The redox flow battery according to claim 1, wherein the at least one electrode and the at least one membrane are each at least partially connected in a fluid-tight manner laterally around a circumference.

3. The redox flow battery according to claim 1, wherein the at least one electrode and the at least one membrane are each at least partially connected in a fluid-tight manner to at least one side plate around the circumference.

4. The redox flow battery according to claim 1, wherein the at least one fluid-tight connection is a materially-bonded connection.

5. The redox flow battery according to claim 1, wherein the at least one electrode and the at least one membrane are at least partially directly connected to one another in a fluid-tight manner with at least one of
the half-cell interior space being at least partially sealed in a fluid-tight manner, or
the at least one electrode and the at least one membrane being at least partially directly connected to at least one side plate in a fluid-tight manner.

6. The redox flow battery according to claim 1, wherein the at least one at least partially fluid-tight half-cell interior space is formed between the at least one electrode, the at least one membrane and the fluid-tight connection between the membrane and the electrode and/or, in that at least one at least partially fluid-tight half-cell interior space is formed between the at least one membrane, the at least one electrode and the fluid-tight connections of the membrane and the electrode to the at least one side plate.

7. The redox flow battery according to claim 6, wherein the at least one materially-bonded connection is one of an adhesive bond and a welded joint.

8. (canceled)

9. The redox flow battery according to claim 1, wherein at least one half-cell has at least one cell frame and that at least one cell frame is stacked with at least one membrane and at least one electrode.

10. The redox flow battery according to claim 1, wherein the at least one half-cell interior space has at least one electrolyte feed and/or at least one electrolyte discharge and that at least one electrolyte feed and/or at least one electrolyte discharge is formed by at least one opening in at least one fluid-tight connection formed between at least one membrane and at least one electrode.

11. The redox flow battery according to claim 9, wherein at least one of the half cells has at least one electrolyte feed and/or one electrolyte discharge and that at least one electrolyte feed and/or at least one electrolyte discharge are each formed at least partially by at least one cavity in a cell frame and a passage opening arranged laterally in a cell frame.

12. The redox flow battery according to claim 11, wherein the at least one half-cell has at least one electrolyte feed and/or at least one electrolyte discharge, a cell frame is formed by at least two cell frame elements and that at least one electrolyte feed and/or at least one electrolyte discharge is formed at least partially by at least one free space between at least two cell frame elements.

13. The redox flow battery according to claim 12, wherein the at least one electrolyte feed is connected to at least one electrolyte feed line and at least one electrolyte discharge is connected to at least one electrolyte discharge line and that at least one electrolyte feed line and/or at least one electrolyte discharge line extends outside the stacking surface of the electrode and/or the stacking surface of the membrane and/or the stacking surface of the cell frame.

14. The redox flow battery according to claim 3, wherein at least one electrolyte feed line and/or at least one electrolyte discharge line is formed in each case by at least one cavity in at least one side plate.

15. (canceled)

16. The redox flow battery according to claim 9, wherein the at least one cell frame has at least one electrolyte feed and/or at least one electrolyte discharge, and that at least one cell frame at least partially forms at least one electrolyte feed line and/or at least one electrolyte discharge line and that the at least one electrolyte feed and/or the at least one electrolyte discharge is connected in a fluid-tight manner to the electrolyte feed line and/or to the electrolyte discharge line.

17. Method for producing a redox flow battery having at least one cell, wherein a cell is constructed of two half-cells, with each half-cell having at least one half-cell interior space for receiving an electrolyte, each cell being assigned at least one electrode and at least one membrane, and at least one electrode and at least one membrane being arranged in a stack, wherein the method comprises a step of:
fluid-tightly connecting the at least one electrode and the at least one.

18. The Method according to claim 17, wherein the step of connecting the at least one electrode and the at least one membrane partically connects each a fluid-tight manner, laterally around a circumference.

19. The according to claim 17, wherein the step of connecting the at least one electrode and the at least one membrane are at least partially connected in a fluid-tight manner to at least one side plate, around the circumference.

20. The method according to claim 17, wherein the at least one half-cell interior space has at least one electrolyte feed and/or at least one electrolyte discharge and that at least one electrolyte feed and/or at least one electrolyte discharge is formed by at least one opening in at least one fluid-tight connection formed between at least one membrane and at least one electrode.

21. The according to claim 17, wherein each of the half-cells half cell has at least one cell frame, in that the at least one half-cell interior space is formed at least partially by at least one cell frame and in that at least one cell frame, at least one membrane and at least one electrode are arranged in a stack.

22. The method according to claim 17, comprising the step of producing the at least one fluid-tight connection by a materially-bonded connection.

23. (canceled)

24. (canceled)
